(19) United States
(12) Patent Application Publication
(10) Pub. No.: US 2009/0312890 A1
(43) Pub. Date: Dec. 17, 2009

(54) SYSTEM, METHOD, AND COMPUTER READABLE MEMORY MEDIUM FOR REMOTELY CONTROLLING THE MOVEMENT OF A SERIES OF CONNECTED VEHICLES

(76) Inventor: Jay Evans, Cocoa, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/139,805

(22) Filed: Jun. 16, 2008

(51) Int. Cl. G06F 19/00

(52) U.S. Cl. 701/2; 701/20

(57) ABSTRACT

A remote control system for controlling movement of a train comprises one or more sensors positioned relative to a railroad track for detecting the presence of a lead railcar on the track being pushed by a remotely controllable locomotive. The one or more sensors are spaced a distance from a predetermined stop location of a lead railcar and transmit signals when the lead railcar is detected on the track. A programmable controller positioned off-board or wayside receives signals from the one or more sensors and is in radio communication with an onboard operating system of the locomotive. The controller transmits a signal to the locomotive when the lead railcar is detected by a sensor, and in response to the signal the operating system of the locomotive sets a maximum speed setting for the locomotive to travel on the track toward the stop location.

### BACKGROUND OF THE INVENTION

Embodiments of the invention relate generally to locomotives and other vehicles. More specifically, embodiments of the invention pertain to controlling the movement of locomotives.

When a railcar in a train reaches a destination (e.g., the train might include one or more locomotives and a plurality of railcars), a locomotive operator must stop the locomotive so the railcar is positioned at a predetermined stopping point for unloading the railcar cargo. A locomotive operator can remotely control the movement of the locomotive and railcars via an off-board remote control unit. Such remote control units have an operator interface that enables an operator to transmit commands to an onboard slave control unit that is interfaced with the locomotive onboard operating system. These commands generally relate to locomotive movement parameters such as direction of movement, speed, or braking. The remote control unit communicates with the locomotive operating system and/or slave control unit via a radio frequency (RF) communication system.

However, often times an operator commands the locomotive to move too fast and the locomotive is unable to stop the lead railcar before it passes the predetermined stopping point. As a result, the train may collide with and damage loading docks and nearby equipment, and/or damage the railcar. At present, there is not a method or system that provides the automated speed control and stopping of a locomotive and train, when the locomotive is pushing railcars so a lead railcar is properly positioned at a predetermined stopping point for unloading.

Radio frequency identification (RFID) or automated equipment identification (AEI) tags and readers are used to control movement of trains in rail yards. Specially programmed RFID or AEI tags are sometimes mounted on the tracks between the rails to identify speed limits and stopping points for when the locomotive is pulling cars. The locomotive has an RFID or AEI tag reader installed underneath it to read the tags as it crosses over them. This method of controlling a Remote Control Locomotive movement is not applicable to delivery of railcars to an industry location in which the locomotive is pushing or pulling the cars. Railcars cannot be practically equipped with a RFID reader as it requires a power source and radio for a communication link with the locomotive.

In addition, the tracks at rail yards and other destination locations are often times in very poor condition; therefore, systems having components mounted on the track rails such as impedance circuits may not serve as adequate solutions.

### BRIEF DESCRIPTION OF THE INVENTION

Embodiments of the invention relate to systems and methods for controlling the movement of a series of connected vehicles that travel along a designated pathway. One of the vehicles is a powered vehicle for moving the series of vehicles. At least one sensor is positioned relative to the pathway for detecting the presence of a lead vehicle on the pathway, and one sensor is spaced a distance from a stop location of the lead vehicle. The sensor transmits at least one signal when the lead vehicle is detected on the pathway. A controller receives the signals from the sensor and is in communication with an onboard operating system of the powered vehicle. The controller transmits a signal to powered vehicle when the lead vehicle is detected by the sensor, and in response to the signal the operating system of the powered vehicle sets a maximum speed setting for the powered vehicle to travel on the pathway toward the stop location.

In another embodiment, the system may include a plurality of sensors positioned relative to the pathway, spaced apart from one another and spaced a predetermined distance from the stop location of the lead vehicle. As the lead vehicle approaches the stop location, the controller transmits a signal to the powered vehicle each time a sensor detects the lead vehicle on the pathway. Responsive to each signal the onboard operating system of the powered vehicle provides a maximum speed setting for the powered vehicle each time a sensor detects the lead vehicle on the pathway. The maximum speed setting is reduced as the lead vehicle approaches the stop location and trips successive sensors. At the last sensor, or the sensor closest to the stop location, the controller transmits a signal responsive to which the powered vehicle stops a distance from the stop location and the onboard operating system sets a maximum speed setting for the powered vehicle to travel toward the stop location.

### BRIEF DESCRIPTION OF THE DRAWINGS

The present invention can be more easily understood and the further advantages and uses thereof more readily apparent, when considered in view of the following detailed description when read in conjunction with the following figures, wherein:

FIG. 1 is a schematic illustration of a first embodiment of the invention; and

FIG. 2 is a schematic illustration of a second embodiment of the invention.

FIG. 3 is a flow chart showing steps for a method embodiment of the invention.

### DETAILED DESCRIPTION OF THE INVENTION

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained in the context of a locomotive that is pushing a plurality of railcars on a railroad track. However the invention is not so limited but encompasses remotely controlling the movement of a series of connected vehicles that include a powered vehicle that is pushing or pulling the other vehicles on a designated pathway. Accordingly, the invention may be applicable to off-highway vehicles, marine vehicles, on-road vehicles, etc. The term “powered vehicle” as used herein shall comprise the vehicles that have an onboard power source sufficient to propel the vehicle and others in a series of vehicles. In the case of trains traveling on railroad tracks, the locomotive is the powered vehicle. If the locomotive is pulling the railcars, the locomotive is also the “lead vehicle” or “lead railcar” as described below. If the locomotive is pushing the railcars the lead railcar is the railcar disposed at the end of the train opposite the locomotive

Before describing in detail the particular method and apparatus for remotely controlling of movement of a train in accordance with the present invention, it should be observed that the present invention resides primarily in a novel combination of hardware and software elements related to said method and apparatus. Accordingly, the hardware and software elements have been represented by conventional elements in the drawings, showing only those specific details that are pertinent to the present invention, so as not to obscure the disclosure with structural details that will be readily apparent to those skilled in the art having the benefit of the description herein.

With respect to FIG. 1 there is schematically shown a train 10 including a locomotive 11 pushing a plurality of railcars 12. The railcars 12 include a lead railcar 12A that is positioned at an end of the train 10 distal the locomotive 11. The locomotive 11 is pushing the railcars 12 (including the lead railcar 12A) on a track 13 toward a stop location 14 where the lead railcar 12A will be positioned for unloading or loading cargo. The track 13 is dedicated to the stop location 14 for unloading or loading a railcar 12, and is linked to a main track (not shown).

The locomotive 11 is remotely controlled by an operator 15 using a hand held remote control unit 16 that includes an operator interface having various input mechanisms that enable the operator to input commands relative to movement of the locomotive 11 and train 10. The remote control unit 16 is linked with a radio frequency module 17 (representing the onboard communication system) on the locomotive 11 that is a component of the locomotive 11 communications and power distribution system of the locomotive. For example, an operator may control the speed, stopping, and direction of the locomotive 11 by inputting commands in the remote control unit 16. The operator 15, via the remote control unit 16, transmits commands to an onboard operating system 22 to control movement on the locomotive 11 and train 10 on the track 13.

In an embodiment of the disclosed invention, a remote control system 30 is used to restrict the speed of the locomotive 11 as the lead railcar 12A approaches the stop location 14, so the operator 15 can stop the train 10 so that the lead railcar 12A is positioned at the stop location 14. The remote control system 30 comprises a sensor 18 positioned relative to the track 13 to detect the presence of the lead railcar 12A on the track 13. The sensor 18 may be mounted on the track 13, e.g., on a cross tie, or positioned wayside the track 13 to detect the lead railcar 12A a predetermined distance from the stop location 14. When the sensor 18 detects the lead railcar 12A on the track 13, the sensor 18 transmits a signal 20 to an off-board controller 19. In response to receiving signal 20 from the sensor 18, the controller 19 transmits a signal 21 to the locomotive 11. The signal 21 is representative of a command or setting that controls movement of the train 10 on the track. Accordingly, responsive to the receipt of signal 21, the locomotive operating system 22 sets a maximum speed setting for the locomotive 11 to travel on the track 13 toward the stop location 14.

In addition, the operating system 22 may command the locomotive 11 to stop on the track 13, and the operator 15 may remotely control the movement of the locomotive 11 and train 10 toward the stop location 14; however, the operator 15 via the remote control unit 16 can not enable the locomotive 11 to travel at a speed that exceeds the maximum speed setting. In such an embodiment, when the operating system 22 of the locomotive 11 commands the locomotive 11 to stop in response to receiving the signal 21 from controller 19, the remote control unit 16 may be configured to require the operator 15 to enter a command before the locomotive 11 can be moved on the track 13. For example, the remote control unit 16 may include an input mechanism for generating a STOP command, which when completed will enable the operator 15 to move the locomotive 11 and train 10 toward the stop location 14.

In one embodiment, the sensor 18 is an electro-optical sensor such as a through-beam sensor or retro-reflective sensor that is hard-wired to the controller 19, which is housed in a control box. The controller 19 also includes a radio frequency module 23 for communicating with and transmitting signals to the communication system 17 of the locomotive 11. Alternatively, the sensor 18 may have wireless communication capabilities for transmitting signals to the controller 19. In another embodiment, the controller 19 may be integrated with or be a component of the remote control unit 16. In either case, the remote control unit 16 has an operator interface that enables the operator 15 to activate the system so that the operating system 22 on the locomotive 11 can not respond to speed setting commands that exceed the maximum speed setting for the locomotive 11 after the sensor 18 is tripped by the lead railcar 12A.

The speed setting selected may be an arbitrary setting, e.g., 1 mph (1.609 kilometers/hour) for any train 10 and locomotive 11 entering the track 13, or the controller 19 and/or onboard operating system 22 may be programmed to determine the maximum speed setting for a given train 10. When an operator 15 engages the system or activates the controller 19, the controller 19 may prompt the operator 15 to enter data relative to the locomotive 11 and train 10, such as tonnage data, to determine the maximum speed setting. In addition, the controller 19 or onboard operating system 22 may be configured with an algorithm that also factors in the distance the lead railcar 12A must travel to reach the stop location 14 and the grade of the track 13 to determine the speed setting.

In an embodiment, when the lead railcar 12A enters the track 13, an operator engages the controller 19 for linking the controller 19 to the onboard communication system 17 and operating system 22. Radio frequency communication systems are commonly used at rail yards for radio communications between off-board components (such as a remote control unit) and on-board components. Accordingly, one skilled in the art would appreciate how a wayside controller can be linked to an onboard communication system, considering in part the frequency range of the communication system. When the controller 19 is linked to the locomotive communication system 17 and operating system 22, the controller may transmit data via a radio signal indicative of a track identifier. The operating system 22 may include a database that includes data about the location or identification of the sensor 18 (or a plurality of sensors as described below) on the track 13 and data relative to one or more maximum speed settings associated with each sensor 18 location. Accordingly, when the operating system 22 receives signal 21 indicating that the lead railcar has been detected on the track 13, the operating system 22 accesses the database to determine, select, or command a maximum speed setting associated with the sensor 18.

Alternatively, the controller 19 may be programmed and/or configured so that the signal 21 includes a maximum speed setting command. The controller 19 may access a database (not shown) that includes one or maximum speed settings associated with the sensor 18, or one or more speed settings associated with each of a plurality of sensors (described below). When the sensor 18 detects the railcar 12A on the track 13, the controller, via the module 23, transmits a signal or command indicative of the maximum speed setting for the locomotive 11 traveling toward the stop location 14.

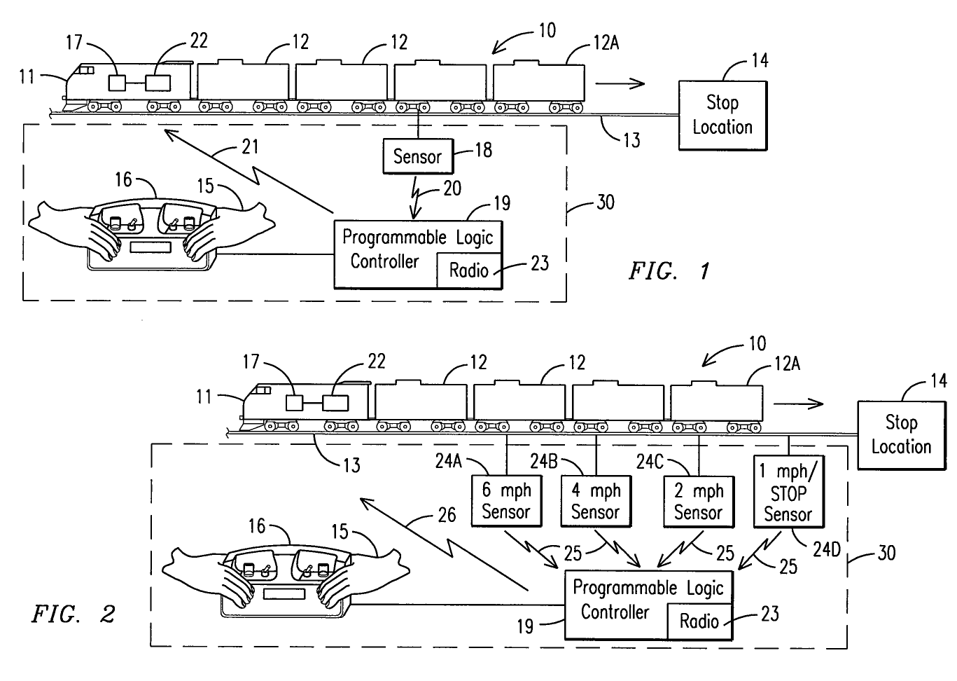

A second embodiment of the invention is shown in FIG. 2 and includes a plurality of sensors 24A-24D positioned relative to the track 13 to detect the lead railcar 12A on the track 13. As shown, the sensors 24A-24D are spaced apart from one another and each is spaced a different predetermined distance from the stop location 14 for the lead railcar 12A. Each sensor 24A-24D transmits a signal 25 to the controller 19 when the lead railcar 12A is detected on the track 13. As indicated above, the controller 19 may incorporate a database that includes data relative to at least one maximum speed setting, and each speed limit is associated with a respective sensor 24A-24D. When the controller 19 receives signal 25 from one of the sensors 24A-24D, the controller 19 transmits a signal 26 to the onboard communication system represented by the module 17 and the onboard operating system 22. The signal 26 is indicative of a maximum speed setting for the locomotive 11 traveling on the track 13 toward the stop location 14. The operating system 22 then automatically sets the maximum speed setting responsive to the signal 26.

This maximum speed setting overrides any speed setting that exceeds the maximum speed setting input by the operator 15 via the remote control unit 16; however, the operator 15 may be able to set speed settings that are less than the maximum speed setting. In an embodiment, the maximum speed setting entered by the operating system 22 may be associated with only the direction of movement toward the stop location 14; so the operator 15 may command any speed in the “pull” direction away from the stop location 14. In reference to FIGS. 1 and 2, when the operating system 22 and onboard communication system 17 receive signals 21 and 26 from the controller 19, the maximum speed setting is entered for the locomotive 11 traveling in reverse; and, the operator 15 may command speeds exceeding the maximum speed setting for the locomotive 11 traveling forward.

With respect to the embodiment shown in FIG. 2, the maximum speed setting may be reduced as the locomotive 11 approaches the stop location. Accordingly, when each sensor 24A-24D is tripped by the lead railcar 12A and the controller 19 transmits signal 26 to the onboard operating system 22 and communication system 17, the maximum speed setting is entered and maintained until the controller 19 transmits a subsequent signal 26 responsive to the lead railcar 12A being detected by the next sensor, thereby reducing the maximum speed setting. For example, when sensor 24A is activated the signal 26 may be indicative of a 6 mph (9.656 kilometers/hour) maximum speed setting; and, when the next sensor 24B is activated the signal 26 is indicative of a 4 mph (6.437 kilometers/hour) maximum speed setting.

In an embodiment, when sensor 24D or the sensor closest to the stop location 14 detects the lead railcar 12A on the track 13, the signal 26 may include a STOP command and a maximum speed setting (e.g., one mile per hour). As described above, the remote control unit 16 may be configured such that once the train 10 and locomotive 11 have stopped; the operator 15 may input a command to move the locomotive 11 further toward the stop location 14. In this manner, the operator may control movement of the locomotive 11 and train 10 toward the stop location 14 so the lead railcar 12 is properly positioned at the stop location 14 for loading or unloading cargo, and the lead railcar 12A does not overrun the stop location, potentially colliding with the loading dock, building, and/or nearby equipment.

As described above, in one embodiment the onboard operating system 22 may be configured to identify the track 13 and the distance between each sensor 24A-24D and/or the distance from each sensor 24A-24D (sensor 18 in FIG. 1) to the stop location. When the controller 19 is initially linked to the onboard communication system 17, the controller 19 may transmit data relative to the track 13 identification and data relative to the distance the sensors 24A-24D (sensor 18 in FIG. 1) are spaced relative to each other and relative to the stop location 14. Alternatively, the onboard operating system 22 may access a database that includes data relative to the distances the sensors 24A-24D are spaced from each other and from the stop location, which data is associated with a track identification name or number. In addition, the database may include, or the controller 19 may transmit data relative to a maximum speed setting for each sensor 24A-24D (sensor 18 in FIG. 1) or for one or more predetermined distances from the stop location, and a distance at which a STOP command is initiated by the operating system 22. When the controller 19 is linked to the onboard operating system 22 and communication system 17 and transmits the track identification data, the onboard operating system 22 may access sensor distance data.

In this manner, in the event there is a communication loss between the locomotive 11 and the controller 19, or if one or more of the sensors 24A-24D (and sensor 18 in FIG. 1) fails, the operating system 22 may initiate the speed setting commands to set a maximum speed setting at a distance a sensor 18, 24A-24D is spaced from the stop location. Alternatively, if there is a communication loss between controller 19 and the locomotive 11, the operating system 22 may initiate a STOP command so the operator 15 may disable the remote control system 30. As known to those skilled in the art, in RF communications systems, signals may be transmitted between communication modules to confirm that a communication link is available or whether there has been an interruption of a communication link. Once the locomotive communication system 17 and the wayside controller 19 are “linked,” there may be periodic communication between these components 17 and 19. A communication loss fault will be declared if this periodic communication is interrupted, forcing the operator 15 to take control of the movement manually.

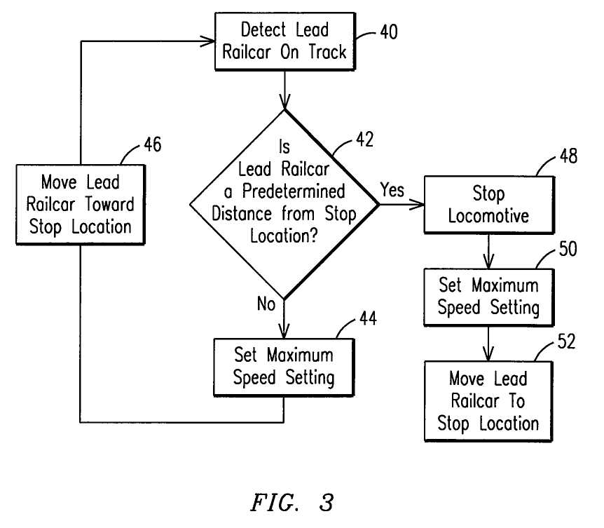

Embodiments of the invention may also be described as a method or computer program. With respect to FIG. 3 there is a flow chart showing different steps of a method, which steps may also be characterized as computer modules for a computer program. An embodiment of the invention may be described as comprising the step 40 of first detecting the lead railcar 12A on the track 13 a distance from the stop location; and then in step 44 setting a maximum speed setting for the locomotive 11 to travel toward the stop location.

In step 42 the controller 19 or the onboard operating system 22 determines whether the lead railcar 12A is a predetermined distance from the stop location 14 in order to stop the locomotive 11. As described above in an embodiment of the invention utilizing a single sensor 18, in step 48 the operating system 22 may respond to a signal received from the controller 19 by commanding the locomotive to stop a distance from the stop location 14 before operator 15 can control movement of the train 10 to the stop location 14. Alternatively, in an embodiment utilizing a plurality of sensors 24A-24A, the operating system 22 may command the locomotive 11 to stop (step 48) when the last sensor 24D closest to the stop location 14 is tripped. In either case, in step 50 the operating system 22 sets a maximum speed setting at which the locomotive 11 may travel toward the stop location; and, in step 52 an operator 15 remotely controls the movement of the train 10 so the lead railcar 12A is positioned at the stop location 14.

If the lead railcar 12A is not a predetermined distance from the stop location 14, or a STOP command is not initiated, the locomotive operating system 22 still enters a maximum speed setting in step 44. In step 46, the locomotive 11 continues to push the railcars 12 toward the stop location 14 until a signal is received that indicates that the lead railcar 12A is at the predetermined distance from the stop location. In this manner, the operator can control movement of the train, including the locomotive 11 and lead railcar 12A, to the stop location 14 at a safe speed without overrunning the stop location 14.

Embodiments described above may be implemented on a suitable computer system, controller, memory, or generally a computer readable medium. For example, the steps of the methods described above may correspond to computer instructions, logic, software code, or other computer modules disposed on the computer readable medium, e.g., floppy disc, hard drive, ASIC, remote storage, optical disc, or the like. The computer-implemented methods and/or computer code may be programmed into an electronic control unit of an engine, a main control system of the locomotive, a remote control station that communicates with the locomotive unit, or the like, as described above.

While various embodiments of the present invention have been shown and described herein, it will be obvious that such embodiments are provided by way of example only and not of limitation. Numerous variations, changes and substitutions will occur to those skilled in the art without departing from the teaching of the present invention. Accordingly, it is intended that the invention be interpreted within the full spirit and scope of the appended claims.

1. A remote control system for controlling the movement of a series of connected vehicles that travel along a designated pathway, one of said vehicles being a powered vehicle for moving the series of vehicles, said system comprising:
at least one sensor positioned relative to the pathway for detecting the presence of a lead vehicle on the pathway, and the at least one sensor is spaced a distance from a stop location of the lead vehicle, and transmits at least one signal when the lead vehicle is detected on the pathway; and,
a controller for receiving signals from the sensor and in communication with an onboard operating system of the powered vehicle, and the controller transmits a signal to the powered vehicle when the lead vehicle is detected by the sensor, and in response to the signal the operating system of the powered vehicle sets a maximum speed setting for the powered vehicle to travel on the pathway toward the stop location.

2. The remote control system of claim 1, wherein the powered vehicle is pulling the other vehicles and the powered vehicle is the lead vehicle.

3. The remote control system of claim 1, wherein the powered vehicle is pushing the other vehicles and the lead vehicle is a vehicle disposed at a distal end of the series of vehicles relative the powered vehicle.

4. The remote control system of claim 1, wherein the operating system on the powered vehicle is configured to command the powered vehicle to stop so the lead vehicle is stopped a distance from the stop location when it receives the signal from the controller and the lead vehicle cannot exceed the maximum speed setting traveling from the point where the lead vehicle stops toward the stop location.

5. The remote control system of claim 1, further comprising a plurality of sensors positioned relative to the pathway for detecting the presence of a vehicle in the series of vehicles on the pathway being moved by the remotely controllable powered vehicle, and the sensors are spaced apart from one another, and each sensor is positioned a distance from the stop location of the lead vehicle, and each sensor transmits a signal to the controller when the lead vehicle is detected on the pathway.

6. The remote control system of claim 5, wherein the plurality of sensors includes at least a first sensor and at least a second sensor, wherein the first sensor is spaced a distance from the stop location and the second sensor is positioned between the first sensor and the stop location, and the onboard operating system sets a first maximum speed setting when the first sensor detects the lead vehicle on the pathway and reduces maximum speed setting of the powered vehicle when the second sensor detects the lead vehicle on the pathway.

7. The remote control system of claim 1, wherein the controller is a component of an off-board remote control unit having an operator interface including an input mechanism to activate the controller to provide the maximum speed settings when the sensor detects the lead vehicle on the pathway and the onboard operating system is configured not to respond to commands to exceed the maximum speed settings from the remote control unit.

8. The remote control system of claim 7, wherein the operating system of the powered vehicle is configured not to respond to commands to exceed the maximum speed settings from the remote control unit when the powered vehicle is moving in a first direction and is configured to respond to commands to exceed the maximum speed setting when the powered vehicle moving in a second direction.

9. The remote control system of claim 1, further wherein the controller is positioned wayside the pathway as a component separate from a remote control unit an operator uses to control movement of the powered vehicle on the pathway, and the onboard operating system is configured not to respond to commands to exceed the maximum speed settings from the remote control unit.

10. The remote control system of claim 9, wherein the operating system of the powered vehicle is configured not to respond to commands to exceed the maximum speed settings from the remote control unit when the powered vehicle is moving in a first direction and is configured to respond to commands to exceed the maximum speed setting when the powered vehicle moving in a second direction.

11. The remote control system of claim 1, wherein the operating system of the powered vehicle accesses data relative to an identification of the pathway and data relative to one or more maximum speed settings associated with one or more distances the lead vehicle is spaced from the stop location.

12. The remote control system of claim 11, wherein the operating system accesses data relative to a location the lead vehicle is stopped a distance from the stop location and at least one maximum speed setting for the powered vehicle to travel toward the stop location.

13. The remote control system of claim 1, wherein in the powered vehicle is a locomotive and the other vehicles are a plurality of railcars linked together and to the locomotive, and the pathway is a railroad track.

14. The remote control system of claim 13, wherein the locomotive is pushing the railcars and the lead vehicle is a railcar disposed at a distal end of the series of railcars relative to the locomotive.

15. A method for controlling the movement of a train including at least one locomotive pushing a plurality of railcars wherein the railcars include a lead railcar linked at an end of the railcars distal the locomotive and the locomotive having an onboard operating system, the method comprising:
detecting the presence of a lead railcar on the track being pushed by the remotely controllable locomotive a predetermined distance from a stop location of the lead railcar; and,
setting a maximum speed setting of the locomotive, responsive to a signal transmitted from a controller off-board the locomotive, for pushing the railcars on the track for the distance from the location the lead railcar is detected on the track to the stop location.

16. The method of claim 15, further comprising detecting the lead railcar at a plurality of different locations on the track and each location is spaced a predetermined distance from the stop location, and setting a maximum speed setting of the locomotive each time the lead railcar is detected on the track in response to a signal transmitted from the controller to the locomotive.

17. The method of claim 16, wherein the detecting step comprises detecting the lead railcar at a first location that is a first predetermined distance from the stop location, and detecting the lead railcar at a second location that is a second predetermined distance from the stop location and the second predetermined distance is shorter than the first predetermined distance, and setting a first maximum speed setting for the locomotive for traveling on the track from the first location to the second location, and setting a second maximum speed setting that is less the first maximum speed setting after detecting the lead railcar at the second location.

18. The method of claim 15, further comprising stopping the locomotive to stop a predetermined distance from the stop location in response to the signal transmitted from the controller when the lead railcar is detected on the track.

19. The method of claim 15, further comprising providing a remote control unit for controlling movement of the train on the track, wherein the remote control unit has a controller that is configured to control movement of the locomotive when the locomotive is pushing and pulling the railcars, and the locomotive cannot exceed the maximum speed settings when the locomotive is pushing the railcars responsive to commands from the remote control unit.

20. The method of claim 19, wherein the remote control unit is configured to control the locomotive to exceed the maximum speed settings when the locomotive is pulling the railcars away from the stop location.

21. A computer readable memory medium that stores a program for controlling the movement of a train including at least one locomotive pushing a plurality of railcars, wherein the railcars include a lead railcar linked at an end of the railcars distal the locomotive and the locomotive having an onboard operating system, the program comprising:
a computer module for detecting the presence of a lead railcar on the track being pushed by a remotely controllable locomotive a predetermined distance from a stop location of the lead railcar; and,
a computer module for setting a maximum speed setting of the locomotive, responsive to a signal transmitted from a controller off-board the locomotive, for pushing the railcars on the track for the distance from the location the lead railcar is detected on the track to the stop location.

22. The computer readable memory medium of claim 21, further comprising one or more computer modules for detecting the lead railcar at a plurality of different locations on the track and each location is spaced a predetermined distance from the stop location, and setting a maximum speed setting of the locomotive each time the lead railcar is detected on the track in response to a signal transmitted from the controller to the locomotive.

23. The computer readable memory medium of claim 22, wherein the computer module for detecting comprises one or computer modules for detecting the lead railcar at a first location that is a first predetermined distance from the stop location, for detecting the lead railcar at a second location that is a second predetermined distance from the stop location and the second predetermined distance is shorter than the first predetermined distance, and for providing a first maximum speed setting for the locomotive for traveling on the track from the first location to the second location, and for providing a second maximum speed setting that is less the first maximum speed setting after detecting the lead railcar at the second location.

24. The computer readable memory medium of claim 21, further comprising a computer module for stopping the locomotive at a predetermined distance from the stop location in response to the signal transmitted from the controller when the lead railcar is detected on the track.

25. The computer readable memory medium of claim 21, further comprising one or more computer modules for controlling a remote control unit, said remote control unit having a controller that is configured to control movement of the locomotive when the locomotive is pushing and pulling the railcars, said one or more computer modules for controlling the remote control unit including instructions that when executed by the controller of the remote control prevent the locomotive from exceeding the maximum speed settings when the locomotive is pushing the railcars responsive to commands from the remote control unit.

26. The computer readable memory medium of claim 25, further comprising a computer module that includes instructions that when executed by the controller of the remote control unit enable the locomotive to exceed the maximum speed settings when the locomotive is pulling the railcars away from the stop location.
